(19) United States
(12) Patent Application Publication
(10) Pub. No.: US 2013/0263820 A1
(43) Pub. Date: Oct. 10, 2013

(54) INTEGRATED LEAN BURN STABILIZERS

(71) Applicants: Robert C. Yu, Santa Clara, CA (US); Ming-Li Hsu Yu, Santa Clara, CA (US); Robert C. Yu, JR., Santa Clara, CA (US)

(72) Inventors: Robert C. Yu, Santa Clara, CA (US); Ming-Li Hsu Yu, Santa Clara, CA (US); Robert C. Yu, JR., Santa Clara, CA (US)

(21) Appl. No.: 13/858,474

(22) Filed: Apr. 8, 2013

Related U.S. Application Data
(60) Provisional application No. 61/621,557, filed on Apr. 8, 2012.

(51) Int. Cl. F02B 17/00

(52) U.S. Cl. CPC F02B 17/005
USPC 123/295

(57) ABSTRACT

An integrated lean burn stabilizer (ILBS) for initiating combustion in an internal combustion engine by generating and introducing active free radicals into a combustion chamber is provided. Engines equipped with the ILBS can achieve a fuel efficient clean combustion processes with a lean and/or diluted mixture otherwise incapable of auto ignition and provide a controlled start of combustion, in conjunction with early in-cylinder direct injection, late diesel-like in-cylinder direct injection, and mixed fuel functions allowing control of the composition and stratification of the mixture. Controlled aspects of the fuel mixture include the equivalent ratio and fuel reactivity combinations inside the main combustion chamber, thereby allowing the start of combustion and duration of combustion inside the main combustion chamber be optimized for maximum cycle efficiency and specific power output while minimizing emissions. The early direct injection function of ILBS can also address the potential issue of homogeneity of port injected low-volatility fuel mixture entering the combustion chamber.

The present application claims the benefit of U.S. Provisional Patent Application No. 61/621,557 filed on Apr. 8, 2012, which is hereby incorporated by reference.

### TECHNICAL FIELD

The present invention relates to combustion systems utilized in internal combustion engines.

### BACKGROUND OF THE INVENTION

Internal Combustion (IC) engines have been the prime mover for more than a century. Nevertheless there remain opportunities for continuous improvement in key engine attributes such as specific power output, fuel economy, and exhaust emissions. The United States consumed about 21 million barrels of petroleum a day in 2010. Of the total petroleum consumed the fraction of petroleum imported into US is about 50%, and roughly equal to that consumed in the ground transportation sector, mainly internal combustion engines. Additionally, evidence indicates that Carbon Dioxide (CO₂) is related to the global warming through the greenhouse effect. Any improvement in fuel economy will lead to lower CO₂ emissions. The improvement of specific power output could also lead to a lighter weight engine, and a further improvement in vehicle fuel economy. The present invention represents an important discovery in the IC engine technologies to improve the above-mentioned attributes.

The Compression Ignition Direct Injection (CIDI) diesel engine burns 30% to 50% less fuel compared to a similar size Homogeneous Charge Spark Ignition (HCSI) gasoline engine, but with the disadvantages of increased Nitric Oxide (NOₓ) and Particulate Matter (PM) emissions, start-ability, and specific power output. On the other hand HCSI gasoline engines offer the advantages of lower NOₓ and PM emissions, improved start-ability, and specific power output, but with poor fuel economy and drive-ability. A hybrid of CIDI and HCSI processes such as Homogeneous Charge Compression Ignition (HCCI) or Premixed Charge Compression Ignition (PCCI) has the potential to be highly efficient and to produce very low exhaust emissions. Nevertheless many major technical barriers must be overcome to achieve the above objectives. Significant challenges include controlling ignition timing and burn rate over all engine operating conditions, poor cold starts and transient response, and high hydrocarbons (HC) and carbon mono-oxide (CO) emissions.

Much progress has been made on Compression Ignition Direct Injection (CIDI) diesel engine exhaust emissions over the past ten years. However, the solutions are complex and require very expensive exhaust emissions after-treatment technologies. Additionally the emissions standards are achieved at the expense of start-ability, drive-ability, specific power output, and fuel economy due to many tradeoffs among Brake Specific Fuel Consumption (BSFC), Brake Mean Effective Pressure (BMEP), Brake Specific Nitric Oxide emissions (BSNOₓ), and Brake Specific Particulates Matter emissions (BSPM).

For the compression ignition operations such as CIDI, HCCI, and PCCI, the formation of active radicals (i.e., reactive chemical species such as .H, .OH, and .OH) in the main fuel charge leads to ignition. The pre-ignition process is controlled mainly by hydrogen peroxide decomposition. Hydrogen peroxide decomposes into two OH radicals that are very efficient at attacking the fuel and releasing energy. Although the amount of energy liberated is at first too small to be considered ignition, these low temperature reactions quickly drive the mixture up to the 800-1,100 deg K necessary for H₂O₂ decomposition and main ignition, depending on the type of fuel used. The process is dominated by the kinetics of local chemical reactions. A small temperature difference inside the cylinder has a considerable effect on the ignition timing of the main fuel charge due to the sensitivity of chemical kinetics to temperature. As a result, heat transfer and mixing are important in forming the condition of the charge prior to ignition. The quality of the mixture and the fuel air ratio supplied to each cylinder should be uniform from cylinder-to-cylinder and cycle-to-cycle. However, due to the transient nature of the IC engines with continuous changing of engine operating and boundary conditions, experts in the field have been unable to control compression ignition timing by directly managing the conditions and composition of the main fuel charge through the whole cycle of intake and compression strokes. The ignition timing of a conventional diesel engine is controlled indirectly by the injection timing of the main fuel charge. That is, the start of ignition timing is equal to the start of injection timing plus ignition delay. Unless the ignition delay can be fixed or made to be near zero, the start of ignition cannot be controlled completely by the injection timing of the main fuel charge. Furthermore, for a HCCI or PCCI engine there is no in-cylinder direct injection timing of the main fuel charge to vary. The main fuel charge is well mixed before entering into the combustion chamber and/or before the beginning of compression stroke. Uncontrolled ignition timing leads to an uncontrolled combustion and excessive engine knocking.

Many attempts to control the compression ignition timing of a conventional direct injection diesel engine by managing directly the conditions and composition of the main charge have been unsuccessful. Certain efforts were designed to improve the fuel atomization and mixture preparation processes through the use of an auxiliary compressed air supply without addressing and controlling the appropriate conditions of temperatures and pressures histories (U.S. Pat. Nos. 4,846,114 and 5,119,792). Others were to heat up the fuel spray to improve the pre-ignition process through the use of electrical heating elements but at the expense of operational safety, very high unburned hydrocarbon emissions, and compromising the main fuel charge injection characteristics (see U.S. Pat. Nos. 4,603,667; 4,787,349; 4,926,819; 6,722,339; 6,289,869, and 6,378,485).

A fuel reactivity stratification with two or more different fuel types supplied with different fuel systems was proposed for engine operations at limited operating speed and load ranges with some degree of control of ignition timing and burn rate but at the expense of complexity, high unburned hydrocarbon emissions, and significant intake throttling loss (US Patent Application 2012/0247421A1). None of the systems were sufficiently rapid and flexible enough to achieve the necessary conditions of temperature, pressure, and mixture composition histories for a controlled ignition process. In addition, a compromise on the main injection characteristics can lead to a poor main combustion process and to very high levels of smoke. Progress was made by an invention that separates the high temperature combustion chemical reaction of the main fuel charge from the low temperature pre-ignition chemical reaction process with an active radical initiator that controls the ignition timing of the main fuel charge with minimum or no ignition delay (U.S. Pat. No. 7,464,688 B2).

The present invention represents an effort to obtain very low engine exhaust emissions while improving fuel economy and start-ability, increasing power density and drive-ability, and maintaining excellent reliability and durability. This is achieved with the use a lean and/or diluted fuel mixture in conjunction with the added functions and capabilities of Active Radical Initiator (U.S. Pat. No. 7,464,688 B2), called Integrated Lean Burn Stabilizer solution (ILBS) which can provide a precise start of ignition, maintain combustion stability at very cold environments, and extend the lean limit of combustion to achieve a highly efficient and clean combustion process.

### SUMMARY OF THE INVENTION

An object of the present invention is to remove or minimize the tradeoffs among Brake Specific Fuel Consumption (BSFC), Brake Mean Effective Pressure (BMEP), Brake Specific Nitric Oxide emissions (BSNOx), and Brake Specific Particulates Matter emissions (BSPM) of IC engines.

It is a further object of the invention to provide a device that can be used as a cold starting aid and or a cold start white smoke control by an instant ignition of the main fuel charge mixture at relatively low compressions temperatures caused by a low ambient temperature operations while avoiding the need for using a glow plug or an intake heater.

It is a further object of this invention to provide a cost effective integrated lean burn stabilizer solution that allows port injected gasoline and natural gas engines to significantly improve the fuel economy and exhaust emissions while achieving diesel-like operation without the throttling of intake charge and the need of a spark ignition system.

It is a further object of the present invention to provide an integrated lean burn stabilizer solution with early in-cylinder direct injection function that allows an additional flexibility in altering the composition and stratification of the mixture including equivalent ratio (equivalent ratio=FA_{actual}/FA_{theoretical}, where FA=fuel/air ratio), and fuel reactivity combination inside the main combustion chamber for a clean and efficient combustion process; and allow a substitution of port injection to address the potential issue of the homogeneity and wall wetting of port injected low volatility fuel mixture entering the combustion chamber due to the high vaporization temperature of low-volatility fuel such as diesel.

It is a further object of the invention to provide an integrated lean burn stabilizer solution with late in-cylinder diesel like direct injection capability that allows a constant pressure cycle operation for achieving a very high specific power output and low engine-out NOₓ, CO, and HC emissions without exceeding the engine existing designed mechanical loading limit.

It is a further object of the invention to provide an integrated lean burn stabilizer solution that allows a mixed fuel capability including petroleum and/or non-petroleum based fuels such as, diesel, gasoline, propane, kerosene, natural gas, hydrogen, methanol, ethanol, and others for controlling the fuel reactivity combination and burn rate to maximize the engine cycle efficiency.

It is a further object of the invention to provide a multi-mode engine and control scheme for operating the engine in a manner to optimally maximize efficiency and performance while minimizing emissions.

These and other objects are accomplished by new design function of the active radicals generation in conjunction with incorporating early in-cylinder direct injection, late in-cylinder diesel-like direct injection, and a mixed fuel capabilities. The active radicals are provided by extracting a portion of the charge (air or air plus diluent) or fuel-charge mixture from the main combustion chamber, treating the portion with or without modifying its composition to initiate active radicals in the portion and returning the portion to the mixture in the main combustion chamber for a spontaneous ignition process.

Further scope of applicability of the present invention will become apparent from the detailed description given hereinafter. However, it should be understood that the detailed description and specific examples, while indicating preferred embodiments of the invention, are given by way of illustration only, since various changes and modifications will become apparent to those skilled in the art from this detailed description.

### BRIEF DESCRIPTION OF THE DRAWINGS

FIG. 1 is a schematic diagram depicting an internal combustion engine in accordance with one aspect of the invention.

FIG. 2 is a cross sectional view of an embodiment of an Integrated Lean Burn Stabilizer-Basic (ILBS-Basic).

FIG. 2A illustrates the “at least one orifice” included in the nozzles of the ILBS devices disclosed.

FIG. 3 is a cross sectional view of an embodiment of a Lean Burn Stabilizer-Plus (ILBS-Plus).

FIG. 4 is a cross sectional view of an embodiment of a Lean Burn Stabilizer-Super (ILBS-Super).

FIGS. 5a, 5b, and 5c are schematic diagrams showing electromagnetic, hydraulic and cam drive mechanisms for the various ILBS devices.

FIG. 6 is a cross sectional view of an embodiment of an Integrated Lean Burn Stabilizer-Basic capable of enriching the compression chamber with additional fuel prior to compression.

### DETAILED DESCRIPTION OF THE PREFERRED EMBODIMENTS

In particularly useful embodiments, the invention uses a lean and diluted fuel mixture in conjunction with a device, designated an integrated lean burn stabilizer (ILBS) to allow the start of combustion and the burn rate of various fuel mixtures inside the main combustion chamber to be controlled in a manner to achieve very low exhaust emissions while maximizing fuel economy and specific power output, and improving start-ability and drive-ability.

### GENERAL ASPECTS OF THE PRESENT DISCLOSURE

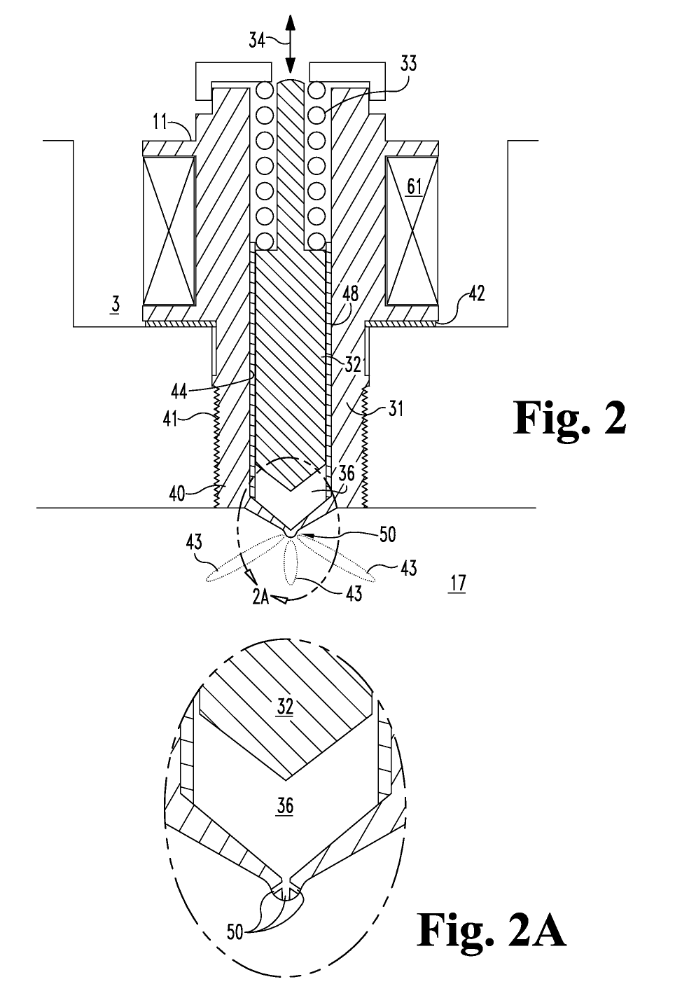

In its broadest form, the present disclosure provides for an Integrated Lean Burn Stabilizer (ILBS) suitable for use in an internal combustion engine and designated as the ILBS Basic. The device includes a housing having an interior chamber (See 44 in FIG. 2) capable of receiving a ceramic sleeve and a nozzle adapted to provide at least one orifice for movement of a fuel/air mixture between the stabilizer and a combustion chamber, a plunger within the interior chamber. The plunger is capable of extension and retraction to provide a reciprocal motion, such that when refracted, the plunger defines a single ILBS chamber within the interior of the ILBS nozzle. Upon retraction of the plunger, a fuel/air mixture present within the combustion chamber is withdrawn through the nozzle into the ILBS chamber, and upon extension of the plunger, the fuel/air mixture present therein is compressed, forming and ejecting at least one active radical plume through the at least one orifice into the combustion chamber and igniting the fuel/air mixture therein.

The ILBS Basic can also be fitted a fuel line in communication with a fuel source and the chamber, the fuel line providing a controllable, intermittent fuel supply to the chamber through a valve included in the line between the fuel supply and the chamber, wherein the fuel is selected from the group consisting of main fuel, pilot fuel, and combinations thereof.

A further aspect of the present disclosure involves a stabilizer in which the plunger remains in an extended position during the combustion chamber's intake and exhaust strokes and there is no communication between main combustion chamber and the integrated lean burn stabilizer during intake and exhaust strokes. Additionally, for some applications, the integrated lean burn stabilizer can be fitted with a ceramic sleeve. In addition, the plunger can be moved by a driver including a cam arrangement, a hydraulic arrangement, an electronic arrangement and combinations thereof. The integrated lean burn stabilizer can additionally be equipped with a nozzle having a plurality of orifices positioned and directed to provide a pattern of active radical plumes within the combustion chamber upon extension of the plunger.

A further aspect of the present disclosure involves an integrated lean burn stabilizer (ILBS) for an internal combustion engine designated as the ILBS Plus. The ILBS Plus includes a housing having an interior chamber equipped with a plunger capable of reciprocating therein between an extended position and a retracted position and forming a compression chamber and a pilot fuel metering chamber therein when in a retracted position. The pilot fuel metering chamber is in communication with the compression chamber and a pilot fuel source through a pilot fuel channel. The pilot fuel channel is open when the plunger is in a retracted position and closed when the plunger is in an extended position. The ILBS Plus further includes a nozzle having at least one orifice positioned to provide communication between the combustion chamber and the compression chamber; and a fuel channel in communication with a fuel source. The fuel channel provides a controllable intermittent fuel supply deliverable to the combustion chamber prior to ignition. Upon refraction of the plunger, contents of the combustion chamber (substantially air or a fuel:air mixture) are withdrawn through the at least one orifice into the compression chamber and pilot fuel is provided to the pilot fuel metering chamber. Before extension of the plunger, fuel is delivered to the combustion chamber from the fuel source through the fuel channel forming a fuel/air mixture therein. Upon extension of the plunger, the pilot fuel channel is closed, pilot fuel is introduced to the compression chamber forming an fuel:air/pilot fuel mixture therein, the fuel:air/pilot fuel mixture is compressed to form active radicals, and the radicals are ejected as a radical plume through the nozzle's one or more orifices into the combustion chamber igniting the fuel/air mixture therein.

The fuel channel in the ILBS Plus in communication with a fuel source can be controlled by an ECU, more specifically by an in-line valve controlled by an ECU. The fuel channel can include a cross-drilling through the plunger in communication with a circumferential groove about the plunger in order to provide a controllable intermittent fuel supply deliverable to the combustion chamber prior to ignition. The plunger within the ILBS Plus typically remains in an extended position during the combustion chamber's intake and exhaust strokes and providing no communication between main combustion chamber and integrated lean burn stabilizer (ILBS) during intake and exhaust strokes. The plunger in the ILBS Plus can be moved by a driver including a cam arrangement, a hydraulic arrangement, an electronic arrangement and combinations thereof.

A still further aspect of the present disclosure involves an integrated lean burn stabilizer (ILBS) for an internal combustion engine designated as the ILBS Super. The ILBS Super involves a housing having an interior chamber equipped with a plunger capable of reciprocating therein between an extended position and a retracted position and forming a compression chamber, a pilot fuel metering chamber, and a fuel chamber therein when in a retracted position. The pilot fuel metering chamber is in communication with the compression chamber and with a pilot fuel source through a pilot fuel channel. The fuel chamber is in communication with the compression chamber and with a fuel source through a fuel channel and the pilot fuel channel and the fuel channel are open when the plunger is in a retracted position and closed when the plunger is in an extended position. The ILBS Super further includes a nozzle having at least one orifice positioned to provide communication between the combustion chamber and the compression chamber. Upon retraction of the plunger, contents of the combustion chamber (air or fuel:air mixture) are withdrawn through the one or more orifices into the compression chamber, pilot fuel is provided to the pilot fuel metering chamber, fuel is provided to the fuel metering chamber. Upon extension of the plunger, the pilot fuel channel and the fuel channel are closed, pilot fuel and fuel are both simultaneously introduced into the compression chamber to form a fuel:air/pilot fuel mixture therein, compressed to form active radicals, and the active radicals ejected through the one or more orifices into the combustion chamber, igniting the fuel/air mixture therein.

The plunger within the ILBS Super typically remains in an extended position during the combustion chamber's intake and exhaust strokes and providing no communication between main combustion chamber and integrated lean burn stabilizer (ILBS) during intake and exhaust strokes. In addition, the plunger in the ILBS Super can be moved by a driver including a cam arrangement, a hydraulic arrangement, an electronic arrangement and combinations thereof. Finally, the ILBS Super can be equipped with a fuel channel in communication with a fuel source, for the purpose of providing a controllable intermittent fuel supply deliverable to the combustion chamber prior to ignition.

The plunger in each of the ILBS devices can be moved by a driver selected from the group consisting of a cam arrangement, a hydraulic arrangement, an electronic arrangement and combinations thereof.

A still further aspect of the current disclosure involves an internal combustion engine having at least one main combustion chamber in communication with an integrated lean burn stabilizer (ILBS) adapted for introducing igniting active radicals into a homogeneous or heterogeneous fuel mixture in the main combustion chamber. Introduction of the active radicals into the combustion chamber initiates ignition and combustion of the fuel mixture in the main combustion chamber for a controlled start of combustion with minimum or no ignition delay. The introduction of igniting active radicals is accomplished by compressing and ejecting into the combustion chamber igniting active radicals derived from a fuel: air mixture withdrawn from the combustion chamber and enriched with additional fuel and a pilot fuel.

A still further aspect of the current disclosure involves an internal combustion engine having at least one main combustion chamber in communication with an integrated lean burn stabilizer (ILBS) adapted for introducing igniting active radicals into a homogeneous or heterogeneous fuel mixture in the main combustion chamber and thereby cause the active radicals to ignite and combust the fuel mixture in the main combustion chamber for a controlled start of combustion with minimum or no ignition delay. Additionally fuel is injected from the integrated lean burn stabilizer into the combustion chamber prior to ignition.

The internal combustion engines of this present disclosure can be designed to provide the main fuel mixture that is too lean and/or to diluted and/or or too cold to support auto ignition or spark/plasma ignition, or to support a self-sustaining and propagating flame front in the main combustion chamber and operate efficiently when equipped with an ILBS device. The advantages provided by such engines are provided herein.

Finally a method is provided for generating active radicals for introduction into a combustion chamber. The method involves (a) withdrawing contents from the combustion chamber; and (b) simultaneously enriching the contents withdrawn with fuel and a pilot fuel to form an enriched mixture, and mixing and compressing the enriched mixture to form active radicals capable of igniting contents contained in the combustion chamber. Contents commonly contained in a combustion chamber typically include air, fuel, recycled exhaust gases, and combinations thereof. Although the method is suitable for use in substantially all IC engines, it is particularly suitable for generating active radicals for engines having combustion chambers with contents containing mixtures which are too lean and/or too diluted and/or too cold to support a self-sustaining and propagating flame front. The pilot fuel can be the same or different from the main fuel, depending on the application. Additionally, the pilot fuel can be a premixed combination of fuels with or without other materials and/or additives that promote the production of active radicals upon compression. Additionally, the main fuel can be a single fuel component, or a mixture derived from a plurality of fuel components with or without additives, the main fuel appropriate for fueling an IC engine.

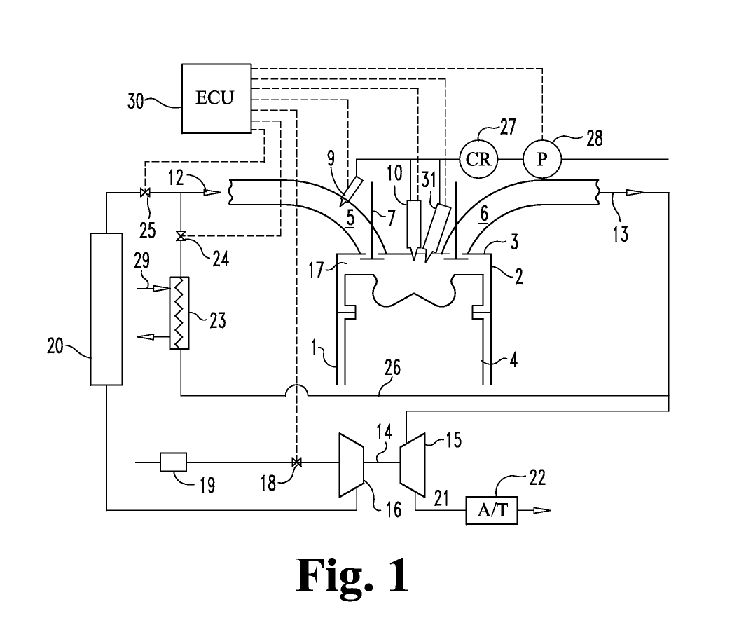

The method of withdrawing can involve withdrawing a mixture of air and fuel, and further involves the step of introducing fuel into the combustion chamber after withdrawing contents from the combustion chamber. In this instance, the fuel introduced directly into the combustion chamber can be a fuel supplement that supplements the main fuel charge already in place or the main fuel charge. Finally, the method can also involve only withdrawing air from the combustion chamber and directly introducing the main fuel charge into the combustion chamber after air is withdrawn. In each instance, the fuel supplement or additional main fuel can be introduced into the combustion chamber through an ILBS device such as the ILBS Plus or through a separate fuel injection device, as illustrated by 31 in FIG. 1. Fuel utilized to supplement the main fuel charge can be the same as or different from the main fuel utilized. It can be appreciated that both the fuel supplement, the main fuel and the pilot fuel can be composed of a single component or include mixtures of various fuel components and additives. One skilled in the art can readily select a fuel supplement, a main fuel, and/or a pilot fuel to optimize performance without undue experimental effort.

FIG. 1 depicts schematically and in cross section a portion of an internal combustion engine pertaining to one embodiment of the present invention. The internal combustion engine is intended to represent any such engine that uses petroleum or non-petroleum based fuel such as for example, gasoline, diesel, propane, kerosene, natural gas, hydrogen, methanol, ethanol, bio-fuel, coal slurry, and others.

Referring to FIG. 1, 1 is an engine body. The body comprises a cylinder block 2, a cylinder head 3, a piston 4, an intake port 5, an exhaust port 6, an intake valve 7, an exhaust valve 8, an ILBS 10, a port injector 9 and/or an in-cylinder direct injector 31. A combustion chamber 17 is formed inside the cylinder block 2, and the main fuel charge is injected from the port injector 9 and/or, in-cylinder direct injector 31, and ILBS 10 into the combustion chamber 17. The ILBS 10 is centrally located in this embodiment.

The intake port 5 is connected to an intake manifold 12, and exhaust port 6 is connecting to an exhaust manifold 13. The engine is provided with a turbocharger 14. Turbocharger 14 includes turbine 15 and compressor 16. A mass flow sensor 18 is provided upstream from the compressor 16 for the purpose of measuring the intake mass flow rate. An air cleaner 19 is provided upstream from the air mass sensor 18. An intercooler 20 is provided downstream from the compressor 16 for the purpose of cooling the intake air. The exit of the exhaust turbine 15 is connected through an exhaust pipe 21 to an exhaust after-treatment device 22. The engine is also equipped with an Exhaust Gas Recirculation (EGR) system. The EGR system comprises an EGR tube 26, EGR cooler 23, and EGR valve 24. The engine cooling water is used to cool the EGR gas. An intake throttle 25 is provided upstream from the connection between the EGR tube 26 and intake manifold 12 for high EGR rate operations.

The ILBS, in-cylinder direct injector, and port injector are connected to a common rail 27 with supply pump 28. Depending on the particular engine and means of introducing the main fuel charge into the combustion chamber, the fuel supply arrangement may be varied.

The port injector 9 can be replaced with an in-cylinder direct injector 31 for a low volatility fuel such as diesel to address the potential issue of the homogeneity and wall wetting if an in-cylinder direct injection function is not included in the ILBS design.

An electronic control unit (ECU) 30 is provided for the purpose of electronically controlling the engine operation including port injection, ILBS, EGR valve, intake throttle, variable valve timing/lift, and etc. to meet the combustion and operation requirements of the present invention.

As shown here the present embodiment is a turbocharged engine, however, the present invention may also be effective in a natural aspirated (NA) or two stroke internal combustion engines.

Operation of an IC Engine Equipped with an ILBS Provides a Highly Efficient and Clean Combustion Processes

The following provides non-limiting examples of results that can be achieved by an IC engine equipped with an ILBS.
The use of a quasi-homogeneous or homogeneous fuel charge in the main combustion chamber with a maximum local equivalent ratio (Phi) less than 2.0:
   provides Soot/PM control via formation rather than oxidation;
   decouples the tradeoff between BSNO_{X} and BSPM;
   provides near zero engines-out soot emissions
   provides reduced high Peak Injection Pressure (PIP) requirement for soot control, and a simpler fuel injection system.
The use of a lean and/or diluted mixture in the main combustion chamber with 1) lambda (lambda=AF_{actual}/AF_{theoretical}, where AF=air/fuel ratio) equal to or greater than 2.0, or 2) oxygen concentration equal to or less than 10%, or 3) a combination of lambda greater than 0.5 and oxygen concentration between 10 and 21% for achieving low combustion temperature (<2000 Deg. K) provides:
   near zero engine-out NOₓ emissions;
   higher specific heat ratio, leading to higher engine thermal cycle efficiency; and
   reduced engine thermal loading, and heat transfer & exhaust energy losses
The use of an ILBS design for a dialed-in start of combustion results in:
   optimum heat release placement for maximum thermal cycle efficiency
   no engine knocking and/or uncontrolled start of combustion
   no excessive rate of pressure rise and improved combustion noise
   the ability of constant pressure cycle operation for very high specific power output without exceeding the engine existing designed Peak Cylinder Pressure (PCP) mechanical loading limit
The use of an ILBS design for maintaining combustion stability with the very lean and diluted mixtures at very cold ambient conditions provides excellent cold start and white smoke control and elimination of the need for minimum compression ratio requirement and the need for a glow plug.

The various embodiments of the ILBS within the scope of the present invention can be designed to meet a variety of requirements for a fuel efficient and clean combustion process. The ILBSs generally perform the following functions individually and collectively:
1. Separates a controllable pre-ignition chemical reaction process of the fuel charge inside the ILBS from an uncontrollable pre-ignition chemical reaction of the main fuel charge inside the combustion chamber, to allow the ignition timing of the main fuel charge be controlled with minimum/no delay between the onset of multiple active radical plumes and the ignition of the main fuel charge.
2. Draws in a controlled amount of the compressed charge to the ILBS's mixing & compression chamber at the appropriate time for the preparation of active radical generation process.
3. Meters a controlled amount of pilot fuel for the preparation of active radical generation process. Pilot fuel is the fuel supplied to the stabilizer to enrich the initial mixture withdrawn from the main combustion chamber. The pilot fuel can be a single fuel type, a mixture of fuel types, and/or include the same fuel supplied to the main combustion chamber. The pilot fuel is selected, in part, for its ability to facilitate the generation of active radicals.
4. Simultaneously injects, mixes, and compresses the pre-determined amount of pilot fuel and compressed charge for the controlled pre-ignition chemical reaction and active radical plumes generation.
5. Injects active radical plumes for a controllable ignition timing of the main charge.
6. Liberates an adequate amount of ignition energy and an appropriate concentration of active radical plumes for a controlled start of combustion of the main fuel charge. In one embodiment, the amount of energy liberated by the ILBS to attack the main fuel charge for the start of the ignition is two orders of magnitude greater than the energy liberated by the spark or plasma plugs used in the todays spark ignited engines. The amount of energy liberated and active radical generated by ILBS can be further optimized by metering the amount of pilot fuel and fuel type inside the ILBS. The resulting high ignition energy and high active radical concentration allows the combustion of main fuel charge to proceed at much leaner conditions, which result in lower peak combustion temperatures and lower NOₓ emissions. The leaner the main charge mixture, the higher the ignition energy and active radical concentration that are required for the combustion of main fuel charge to achieve a fast and clean combustion with optimum heat release placement resulting in high engine thermal cycle efficiency and ultra low exhaust emissions.
7. Provides a function of late in-cylinder diesel-like direct injection for a high specific power output constant pressure cycle operation without exceeding the engine existing designed mechanical loading limit.
8. Provides a function of an early in-cylinder direct injection of a single and/or mixed main fuel to provide an additional flexibility to alter the composition and stratification of the mixture including equivalent ratio, and fuel reactivity combination inside the combustion chamber; and to address the potential issue of homogeneity and wall wetting of port injected low-volatility fuel mixture entering the combustion chamber due to the high vaporization temperature of low-volatility fuel.

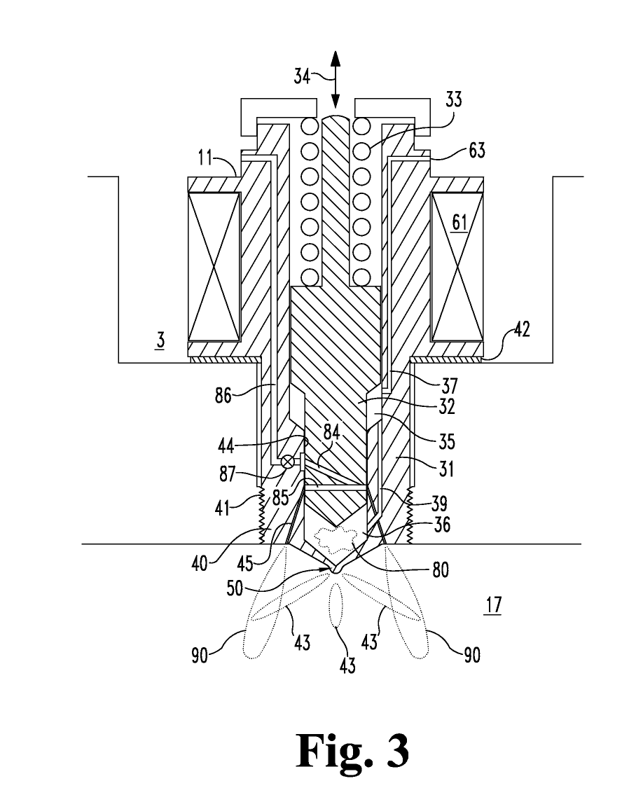

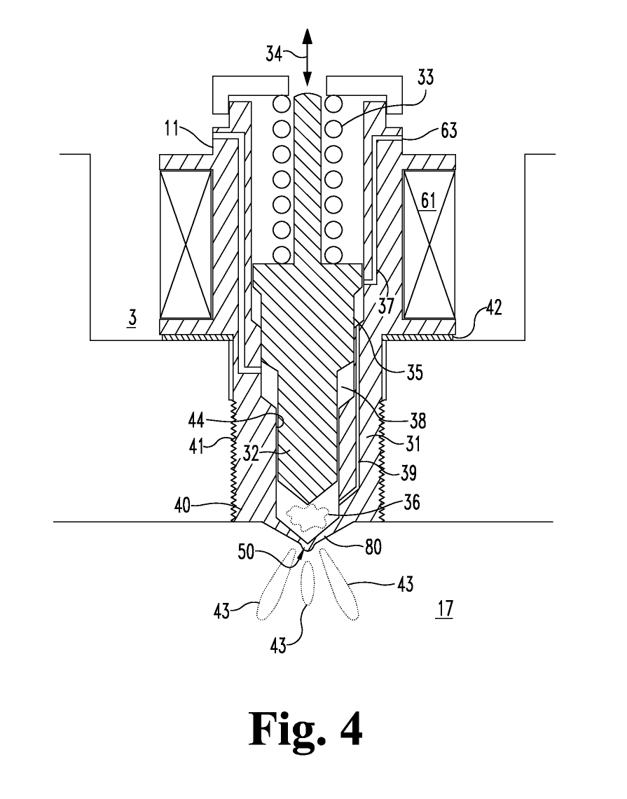

FIGS. 2-4 show schematically the design of various ILBSs to meet the design requirements listed earlier. The ILBS housing 11 of FIG. 2-4 includes a nozzle body 31 equipped with at least one orifice 50 (see FIG. 2A), plunger 32, return spring 33, and the descending and drive mechanism of reciprocable plunger 34. A ceramic sleeve 48 within the nozzle body is incorporated in the ILBS-Basic if a higher compression temperature inside the ILBS is required. A maximum volume of pilot fuel metering chamber 35 (FIGS. 3&4), a maximum volume of main charge direct injection fuel metering chamber 38 (FIG. 4), and a maximum volume of pilot fuel mixing and compression chamber 36 are created when the ILBS plunger is fully retracted. These maximum volumes are determined based on engine size and specific application requirements. The pilot fuel metering chamber 35, main charge direct injection fuel metering chamber 38, and mixing & compression chamber 36 together comprise an interior chamber. The plunger 32 of ILBS-Plus (FIG. 3) has a cross drilling 84 and a circumferential groove 85 for introducing the main fuel charge 90 from the at least one early direct injection fuel supply means 86 into the main combustion chamber 17 though the separate multiple injection nozzle holes 45 inside the nozzle body 31. A valve, 87 (such as, for example, a piezoelectric valve) can be used to control the feed port for a quick open and close of early in-cylinder direct injection process, or a conventional mean of a quick upward and downward movement of the plunger can also be used to control the start and of the early in-cylinder direct injection process. The valve 87 can be replaced with a piezoelectric washer/stack and/or other appropriate mechanisms.

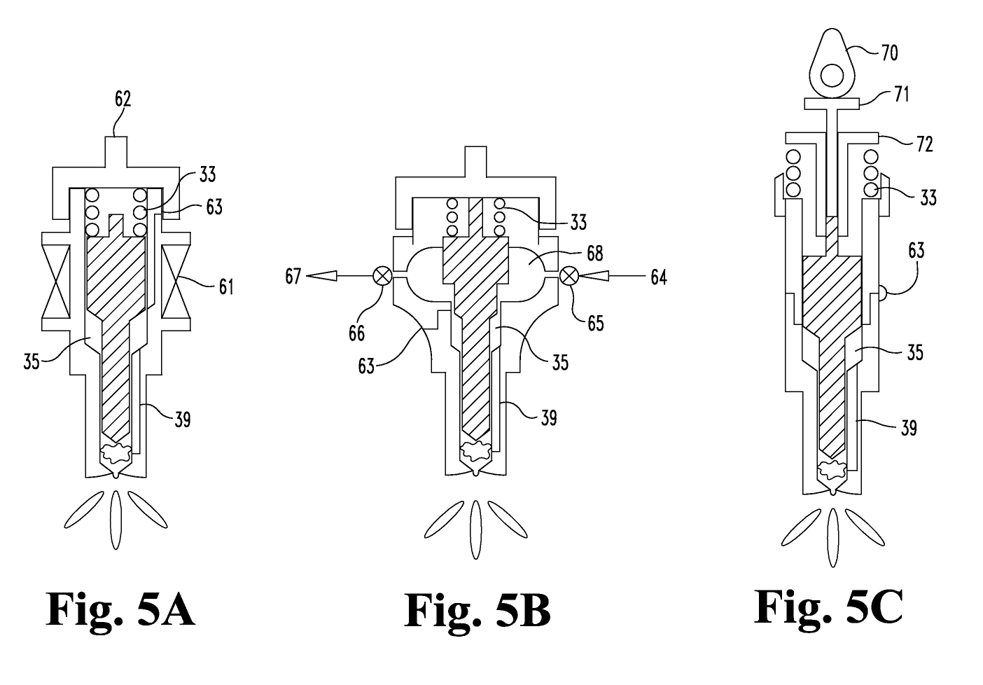

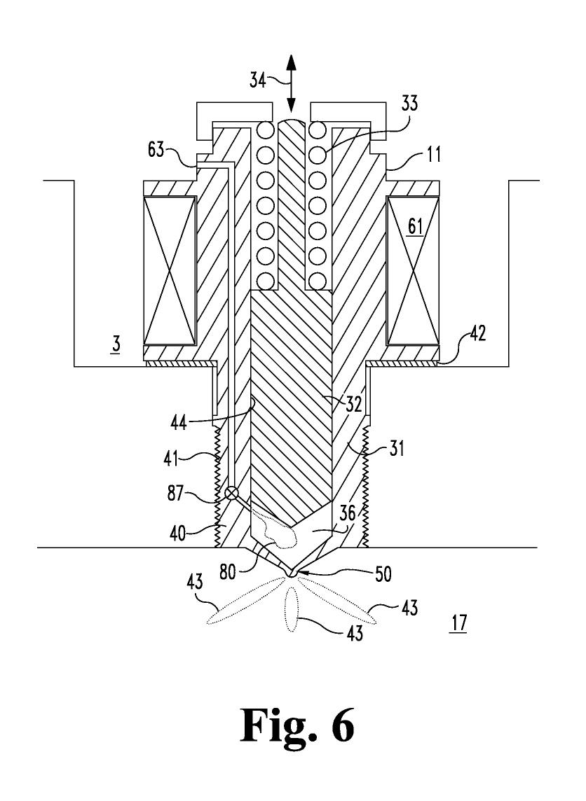

As the plunger of ILBS-Plus or ILBS-Super is descending (moving toward its extended position) both pilot fuel metering chamber 35 and mixing & compression chamber 36 are beginning to decrease to provide compression and mixing energies for the injection, mixing, and compression processes to proceed simultaneously. The pilot fuel inside the metering chamber 35 is supplied through the pilot fuel supply/feed port of nozzle body 37. The pilot fuel supply means/feed port is completely closed during the simultaneous injection, mixing, and compression processes. The descending motion of plunger 32 can be accomplished by any one of various conventional means, such as cam drive, hydraulic drive, or electromagnetic drive 61, as shown in FIGS. 5a-5c. The selection of each approach may depend on the design of the engine and space available for the incorporation of ILBS. In general, a cam drive system offers simplicity, but hydraulic or electromagnetic systems offer flexibility. The compression spring 33 retracts plunger 32. The injection and mixing of pilot fuel is accomplished, as shown in FIGS. 3 and 4, by introducing the pilot fuel from pilot fuel metering chamber 35 into mixing & compression chamber 36 through the nozzle body fueling passage 39. Compression of the prepared fuel-air mixture occurs simultaneously to achieve the optimum conditions of temperature, pressure, and mixture composition histories to achieve the best yield of active radical formation inside the ILBS. The direction and number of active radical plumes 43 are optimized by the nozzle tip holes geometry to achieve the multiple ignition sites for a fast and clean combustion process. ILBS housing 11 may have external threads 40 that mate with internal threads 41 of cylinder head 3, and be sealed thereto via washer 42 (not shown in FIGS. 2-4).

As shown in FIG. 5a and electromagnetic drive system for the ILBS may be driven by solenoid coil 61, and the fuel supply 63 may be introduced to metering chamber 35 via fueling passage 39.

As shown in FIG. 5b, a hydraulic drive system may be utilized by incorporating a hydraulic supply 64 through one-way valve 65 into interior chamber 66. A corresponding outlet one-way valve 66 and outlet port 67 may be incorporated into the opposing side of the ILBS. The hydraulic supply can be integrated into the high pressure common rail system.

As shown in FIG. 5c, a cam drive system may be utilized by incorporating a cam 70 that drives push rod 71 through plunger coupling 72.

There are many applications of various ILBS designs. The ILBS-Basic provides the basic function of igniting active radical generation and multiple active radical plumes injection. It offers the simplicity and low cost. The ILBS-Plus and ISB-Super provide the additional means of controlling the composition and stratification of the mixture including equivalent ratio, and fuel reactivity combination inside the main combustion chamber for optimum peak combustion temperature and heat release duration. Both ILBS-Plus and ILBS-Super can also be used as means of addressing the potential issue of homogeneity and wall wetting of port injected low-volatility fuel mixture entering the combustion chamber due to the high vaporization temperature of low-volatility fuel, in addition to the basic functions provided by ILBS-Basic. Finally The ILBS-Super provides an added function of late in-cylinder diesel-like direct injection for a high specific power output constant pressure cycle operation without exceeding the engine existing designed mechanical loading limit, in addition to the functions provided by ILBS-Plus. Some specific application details and benefits are described as follows:

### Homogeneous Charge Spark Ignition (HCSI) Engines

The ILBS-Basic and ILBS-Plus without early in-cylinder direct injection function can be applied to port injected gaseous or high volatility liquid fueled spark ignition engines including natural gas, methane, propane, hydrogen, gasoline, methanol, ethanol, and etc. For all the conventional spark ignited engines the throttling of the intake charge is required at idle and light load conditions to avoid engine misfire and high unburned hydrocarbons and carbon mono-oxide emissions at the expense of throttling loss. With the substitution of ILBS-Basic or ILBS-Plus for a spark ignition system, the modified engine can be operated at ILBS mode at idle and light load conditions, and gradually transition to ILBS+HCCI mode at medium and high load conditions with a diesel like cycle efficiency and very low exhaust emissions. This is believed to be partly due to the ability of ILBS to ignite and combust a mixture that is too lean to support a self-sustaining and propagating flame front with multiple active radical plumes thereby allowing a charge leaner than is possible in a conventional spark ignited engine, and partly the ability of ILBS to precisely time the start of combustion of the main fuel charge where the vast majority of the premixed charge will burn by compression ignition without the presence of a self-sustaining and propagating flame front such as in a spark ignited engine. The above engines can be further optimized with a centrally located ILBS-Basic or ILBS-Plus, improved combustion chamber design, and higher compression ratio. There is no need for the ILBS-Basic or ILBS-Plus to be located on the cold side of the combustion chamber, as is often true with spark plugs, to avoid engine knocking. The electronic control unit (ECU 30) can effect the transition between ILBS and ILBS+HCCI operating modes.

### CIDI, HCCI, PCCI Engines and its Derivatives

The ILBS-Plus and ILBS-Super can be applied to CIDI, HCCI, PCCI, and its derivatives with diesel, gasoline, propane, kerosene, natural gas, hydrogen, methanol, ethanol, bio-fuel and others. For the gaseous fueled engines a separate supply of at least one liquid pilot fuel such as diesel, gasoline, or various fuel mixes for ILBS-Plus or ILBS-Super may be required. The ignition timing of the lean and/or diluted mixture inside the main combustion chamber is controlled entirely by the onset timing of the multiple active radical plumes of ILBS-Plus or ILBS-Super. In one embodiment, the invention overcomes the major technical barriers of Homogeneous Charge Compression Ignition (HCCI) or Premixed Charge Compression Ignition (PCCI) processes such as controlling ignition timing and burn rate over all engine operating conditions, poor start-ability, poor transient response, and high hydrocarbons and carbon mono-oxide emissions. Also, on some embodiments, improvements in key engine attributes such as specific power output, fuel economy, and exhaust emissions are realized. The existing HCCI and PCCI engines without the present invention can only operate at HCCI or PCCI modes at very limited operating conditions such as part load to medium load, and need to revert to conventional Homogeneous Charge Spark Ignition (HCSI) or Compression Ignition Direct Injection (CIDI) mode at idle, light load, high load, high speed, and for cold start to avoid the uncontrolled combustion, poor start-ability, and high hydrocarbons and carbon emissions. ILBS, ILBS+HCCI, and ILBS+PCCI engines can operate on gasoline, diesel, and alternative fuels. The electronic control unit (ECU 30) can affect the split of main charge fueling between port and ILBS injections depending on the engine operating conditions.

The ILBS-Super can also be applied to a conventional diesel engine with reduced compression ratio and added function of late in-cylinder diesel-like direct injection for a very high specific power output constant pressure cycle operation without exceeding the engine's existing designed mechanical loading limit. The major technical barrier of implementing such an approach is that the conflicting requirement of engine compression ratio affecting the engine start-ability and engine specific output. A good start-ability will require a higher compression ratio; On the contrary, a higher engine specific output will require a lower compression ratio to keep the engine operating within the peak cylinder pressure design limit. In one embodiment, the ability of ILBS to generate multiple active radical plumes to ignite the main fuel charge at a much lower compression temperature and pressure can allow a lower compression ratio high specific output engine to be developed with excellent start-ability and cold start white smoke.

The various ILBS designs of the present invention find application in a variety of combustion systems including internal and external to help achieve low exhaust emissions and high engine thermal cycle efficiency. The system can be applied to petroleum and non-petroleum based fuels including gasoline, diesel, kerosene, methanol, ethanol, natural gas, propane, hydrogen, and etc. The system can also be applied for both mobile and stationary applications including any automotive, locomotive, industrial, marine, military, and power generation. Finally, the ILBS device can be installed in a manner that allows the radical plume ejected to ignite an air:fuel mixture in a combustion chamber or in a pre-combustion chamber.

While applicant's invention has been described in detail above with reference to specific embodiments, it will be understood that modifications and alterations in embodiments disclosed may be made by those practiced in the art without departing from the spirit and scope of the invention. All such modifications and alterations are intended to be covered. In addition, all publications cited herein are indicative of the level of skill in the art and are hereby incorporated by reference in their entirety as if each had been individually incorporated by reference and fully set forth.

We claim:

1. An integrated lean burn stabilizer (ILBS) for an internal combustion engine comprising: a housing having an interior chamber capable of receiving a ceramic sleeve and a nozzle adapted to provide at least one orifice for movement of a fuel/air mixture between the stabilizer and a combustion chamber, a plunger within the interior chamber, the plunger capable of extension and retraction to provide a reciprocal motion, such that when retracted, the plunger defines a single ILBS chamber within the interior of the ILBS nozzle,
wherein upon retraction of the plunger, a fuel/air mixture present within the combustion chamber is withdrawn through the nozzle into the ILBS chamber, and upon extension of the plunger, the fuel/air mixture present therein is compressed, forming and ejecting at least one active radical plume through the at least one orifice into the combustion chamber and igniting the fuel/air mixture therein.

2. The integrated lean burn stabilizer of claim 1, further including a fuel line in communication with a fuel source and the chamber, the fuel line providing a controllable, intermittent fuel supply to the chamber through a valve included in the line between the fuel supply and the chamber, wherein the fuel is selected from the group consisting of main fuel, pilot fuel, and combinations thereof.

3. The integrated lean burn stabilizer of claim 1 wherein the plunger remains in an extended position during the combustion chamber's intake and exhaust strokes and there is no communication between main combustion chamber and integrated lean burn stabilizer during intake and exhaust strokes.

4. The integrated lean burn stabilizer of claim 1, wherein the plunger is moved by a driver selected from the group consisting of a cam arrangement, a hydraulic arrangement, an electronic arrangement and combinations thereof.

5. The integrated lean burn stabilizer of claim 1, wherein the nozzle adapted to provide at least one orifice for movement of a fuel/air mixture between the integrated lean burn stabilizer and a combustion chamber includes a plurality of orifices positioned and directed to provide a pattern of active radical plumes within the combustion chamber upon extension of the plunger.

6. An integrated lean burn stabilizer (ILBS) for an internal combustion engine comprising:
(a) a housing having an interior chamber equipped with a plunger capable of reciprocating therein between an extended position and a retracted position and forming a compression chamber and a pilot fuel metering chamber therein when in a retracted position, said pilot fuel metering chamber in communication with the compression chamber and a pilot fuel source through a pilot fuel channel, said pilot fuel channel open when the plunger is in a retracted position and closed when the plunger is in an extended position;
(b) a nozzle having at least one orifice positioned to provide communication between the combustion chamber and the compression chamber; and
(c) a fuel channel in communication with a fuel source, said fuel channel providing a controllable intermittent fuel supply deliverable to the combustion chamber prior to ignition;
wherein upon retraction of the plunger, contents of the combustion chamber (a fuel:air mixture) are withdrawn through the at least one orifice into the compression chamber and pilot fuel is provided to the pilot fuel metering chamber, before extension of the plunger fuel is delivered to the combustion chamber from the fuel source through the fuel channel forming a fuel:air mixture therein, and upon extension of the plunger, the pilot fuel channel is closed, pilot fuel is introduced to the compression chamber forming a fuel: air/pilot fuel mixture therein, the fuel:air/pilot fuel mixture is compressed to form active radicals, and ejected as a radical plume through the at least one orifice into the combustion chamber igniting the fuel/air mixture therein.

7. The integrated lean burn stabilizer (ILBS) of claim 6, wherein the fuel channel in communication with a fuel source includes a valve controlled by an ECU and a cross-drilling through the plunger in communication with a circumferential groove about the plunger.

8. The integrated lean burn stabilizer (ILBS) of claim 6 wherein the plunger remains in an extended position during the combustion chamber's intake and exhaust strokes and there is no communication between main combustion chamber and integrated lean burn stabilizer (ILBS) during intake and exhaust strokes.

9. The integrated lean burn stabilizer (ILBS) of claim 6, wherein the plunger is moved by a driver selected from the group consisting of a cam arrangement, a hydraulic arrangement, an electronic arrangement and combinations thereof.

10. An integrated lean burn stabilizer (ILBS) for an internal combustion engine comprising:
(a) a housing having an interior chamber equipped with a plunger capable of reciprocating therein between an extended position and a retracted position and forming a compression chamber, a pilot fuel metering chamber, and a fuel chamber therein when in a refracted position, said pilot fuel metering chamber in communication with the compression chamber and with a pilot fuel source through a pilot fuel channel, said fuel chamber in communication with the compression chamber and with a fuel source through a fuel channel, said pilot fuel channel and said fuel channel open when the plunger is in a retracted position and closed when the plunger is in an extended position; and
(b) a nozzle having at least one orifice positioned to provide communication between the combustion chamber and the compression chamber; and
wherein upon retraction of the plunger, contents of the combustion chamber (fuel:air mixture) are withdrawn through the at least one orifice into the compression chamber, pilot fuel is provided to the pilot fuel metering chamber, fuel is provided to the fuel metering chamber and upon extension of the plunger, the pilot fuel channel and the fuel channel are closed, pilot fuel and fuel are introduced to the compression chamber to form a fuel:air/pilot fuel mixture therein, and the fuel/air/pilot fuel mixture is compressed to form active radicals, and the active radicals ejected through the at least one orifice into the combustion chamber igniting the fuel/air mixture therein.

11. The integrated lean burn stabilizer (ILBS) of claim 10 wherein the plunger remains in an extended position during the combustion chamber's intake and exhaust strokes and there is no communication between main combustion chamber and the integrated lean burn stabilizer (ILBS) during intake and exhaust strokes.

12. The integrated lean burn stabilizer (ILBS) of claim 10, wherein the plunger is moved by a driver selected from the group consisting of a cam arrangement, a hydraulic arrangement, an electronic arrangement and combinations thereof.

13. The integrated lean burn stabilizer (ILBS) of claim 10, further including a fuel channel in communication with a fuel source, said fuel channel providing a controllable intermittent fuel supply deliverable directly to the combustion chamber prior to ignition.

14. An internal combustion engine comprising at least one main combustion chamber in communication with an integrated lean burn stabilizer (ILBS) adapted for introducing igniting active radicals into fuel mixture in the main combustion chamber to thereby cause the active radicals to ignite and combust the fuel mixture in the main combustion chamber for a controlled start of combustion with minimum or no ignition delay, wherein introducing igniting active radicals is accomplished by compressing and ejecting into the combustion chamber igniting active radicals derived from a fuel:air mixture withdrawn from the combustion chamber enriched with additional fuel and a pilot fuel.

15. The internal combustion engine of claim 14, wherein the main fuel mixture is too lean and/or to diluted and/or or too cold to support auto ignition or spark/plasma ignition, or to support a self-sustaining and propagating flame front in the main combustion chamber.

16. An internal combustion engine comprising at least one main combustion chamber in communication with an integrated lean burn stabilizer (ILBS) adapted for introducing igniting active radicals into a fuel mixture in the main combustion chamber to thereby cause the active radicals to ignite and combust the fuel mixture in the main combustion chamber for a controlled start of combustion with minimum or no ignition delay, wherein fuel is injected from the ILBS directly into the combustion chamber prior to ignition and the igniting active radicals are introduced into the combustion chamber to initiate the start of combustion.

17. The internal combustion engine of claim 16, wherein the main fuel mixture is too lean and/or to diluted and/or or too cold to support auto ignition or spark/plasma ignition, or to support a self-sustaining and propagating flame front in the main combustion chamber.

18. A method for generating active radicals for introduction into a combustion chamber comprising:
(a) withdrawing contents from the combustion chamber;
(b) simultaneously enriching the contents withdrawn with fuel and a pilot fuel to form an enriched mixture, and mixing and compressing the enriched mixture to form active radicals capable of igniting contents contained in the combustion chamber.

19. The method of claim 18, wherein withdrawing contents from the combustion chamber involves withdrawing a too lean and/or too diluted, and/or too cold mixture.

20. The method of claim 18, wherein withdrawing contents from the combustion chamber involves withdrawing a mixture of air and fuel.

21. The method of claim 18, wherein the steps of enriching, and compressing are carried out in a compression chamber of a device and the compression chamber is only capable of communication with the combustion chamber during the withdrawing step through a subsequent ejecting step, involving the ejection of active radicals.
